(19) United States
(12) Patent Application Publication
(10) Pub. No.: US 2026/0116254 A1
(43) Pub. Date: Apr. 30, 2026

(54) BATTERY CAPACITY BASED STATE OF CHARGE

(71) Applicant: FORD GLOBAL TECHNOLOGIES, LLC, Dearborn, MI (US)

(72) Inventors: Gabrielle Vuylsteke, Ferndale, MI (US); Hao Wu, Northville, MI (US); William T. Moore, Ypsilanti, MI (US); Donnell Matthew Washington, Northville, MI (US)

(21) Appl. No.: 19/368,548

(22) Filed: Oct. 24, 2025

Related U.S. Application Data
(60) Provisional application No. 63/712,074, filed on Oct. 25, 2024.

(51) Int. Cl. B60L 58/15; B60L 7/18

(52) U.S. Cl. CPC B60L 58/15; B60L 7/18; B60L 2240/549; B60L 2250/16

(57) ABSTRACT

A vehicle includes a traction battery and one or more controllers configured to manage charging based on capacity changes independent of open circuit voltage. The controllers determine an updated state of charge when capacity varies and prevent charging when the state of charge exceeds a threshold. In some embodiments, the controllers output a state of certified energy value or adjust displayed charge and range indicators.

### CROSS-REFERENCE TO RELATED APPLICATIONS

This application claims the benefit of U.S. Provisional Application Ser. No. 63/712,074, filed Oct. 25, 2024, the disclosure of which is hereby incorporated in its entirety by reference herein.

### TECHNICAL FIELD

This disclosure relates to vehicle battery management systems.

### BACKGROUND

Upcoming guidelines from the European Union and the United States Environmental Protection Agency (EPA) may require battery State of Certified Energy (SOCE) to be calculated and displayed to the customer with prescribed accuracy. The California Air Resource Board (CARB) provides similar requirements for State of Health, which is equal to SOCE if no battery energy is designed to be in reserve.

### SUMMARY

A vehicle includes a traction battery and one or more controllers configured to manage the charging and energy display functions of the vehicle. The controllers are programmed to determine a state of charge value for the traction battery based on a capacity value, such that when the capacity value changes but the corresponding open circuit voltage remains the same, the state of charge value is updated to reflect the change. The controllers further prevent charging of the traction battery once the updated state of charge value exceeds a threshold. In some embodiments, the controllers also output a state of certified energy value for display based on the updated state of charge, and may adjust a displayed charge percentage or range indicator to provide the operator with accurate, real-time information on battery status. Additionally, the controllers may reduce charging current or disable regenerative braking energy recovery once the state of charge exceeds the threshold.

A vehicle power system includes one or more controllers configured to monitor and manage charging of a traction battery. The controllers are programmed to detect when the state of charge value of the traction battery increases by more than a predetermined amount without a corresponding increase in open circuit voltage, and to prevent further charging in response. In some embodiments, the controllers are further configured to output for display a state of certified energy value derived from the state of charge, or to adjust a displayed charge percentage or range indicator based on the updated state of charge value.

A method includes generating a state of charge value based on a capacity value for the battery, even when no corresponding change occurs in the battery's open circuit voltage. This allows the system to accurately reflect changes in available capacity that may arise due to aging or recalibration, independent of voltage variation. The method further includes preventing charging of the traction battery when the calculated state of charge exceeds a threshold. In some embodiments, the method also includes reducing the charging current or disabling regenerative braking energy recovery when the state of charge exceeds the threshold value.

### BRIEF DESCRIPTION OF THE DRAWINGS

FIG. 1A battery's Open Circuit Voltage (OCV) is composed of contributions from the cathode (positive electrode) and the anode (negative electrode).

FIG. 2 The State of Charge (SOC)-OCV relationship measured on an aged battery cell differs from the Beginning of Life (BOL) relationship and depends on its aged state.

FIG. 3 The SOC-OCV model fit to data from aged cell 1; here results are shown with SOC and SOL as the reference. Individual electrode Open Circuit Potential (OCP) (right) contributions to the overall Open Circuit Voltage (OCV) (left) are shown.

FIG. 4 The SOC-OCV model is fit to data from aged cell 1; here results are shown with capacity as the reference. Individual electrode OCP (right) contributions to the overall OCV (left) are shown.

FIG. 5 Here, four aged cells demonstrate SOC estimation error between −8.4% and 1.6% when a BOL SOC-OCV relationship is used.

FIG. 6 Depending on the initial, final, and change in SOC used to calculate battery capacity and SOCE, uncertainty introduced due to an aged SOC-OCV curve varies. Here, the aged cell 1 is used as an example.

FIG. 7 By prediction how the SOC-OCV curve changes with battery age, error in SOC estimation can be significantly reduced.

FIG. 8 Even with a better SOC-OCV curve and better SOC accuracy, uncertainty in capacity and SOCE introduced due to an aged SOC-OCV curve varies with the initial, final, and change in SOC used in the calculation.

FIG. 9 Predicting the aged SOC-OCV produces more accurate estimates of capacity and SOCE than holding a BOL SOC-OCV constant. Data shown is from aged cell 1 and is another perspective on the analysis depicted in FIG. 8.

FIG. 10A schematic diagram of a vehicle.

FIG. 11 SOC values increase with battery capacity even though OCV remains relatively constant.

### DETAILED DESCRIPTION

Detailed embodiments are described below to illustrate the disclosed concepts. However, these embodiments are provided by way of example only, and the disclosed subject matter may be implemented in various other forms. The drawings are not necessarily to scale, and certain features may be enlarged or reduced to better illustrate specific components or relationships. Accordingly, the structural and functional details set forth herein should not be interpreted as limiting but rather as providing a representative basis to enable those skilled in the art to make and use the disclosed subject matter in different embodiments.

Usable battery energy is the energy that a battery can deliver under a controlled discharge condition (e.g. dynamic certification cycle) before an end criteria is met. SOCE is calculated as the ratio of usable battery energy at a point in life relative to the BOL certified value, rounded to the nearest percent (Equation I).

$$SOCE = \frac{Usable Battery Energy}{Certified Usable Battery Energy} \qquad ( 1 )$$

While the SOCE may be measured experimentally, it should also be estimated by an on-board monitor. This on-board SOCE should be accessible and displayed to the customer, for example on the vehicle dashboard or a mobile-phone application. After a phase in period is complete, these on-board SOCE estimates should be no greater than 5% higher than the true measured SOCE. As automotive companies are motivated to not underestimate the SOCE of vehicles to maintain used vehicle price points and value of electric vehicles, ±5% accuracy on SOCE estimates is a reasonable goal.

Previous publications have explored how the SOC-OCV relationship changes with battery age. Curve-based analysis which relies on SOC-OCV analysis is one of three widely used techniques to understand different contributions to battery loss. Experimental data has further connected degradation modes like loss of lithium inventory and loss of active electrode material to measured changes in the SOC-OCV. There is an interest in the path dependence of battery aging; however, with out in-situ techniques to detect specific aging mechanisms, experimental researchers are often limited to observing high level factors such as measured capacity and the capacity loss rate. They then must infer what internal processes are driving their observations. This limits exploration of how various aging mechanisms interact and are dependent on previous aging.

Others have proposed methods using neural networks to estimate SOC-OCV and capacity with error as low as less than 1% using data from constant current constant voltage charging. However, depending on vehicle computational limitations, this may not be feasible without additional off-board resources. Research is needed to predict changes in aged SOC-OCV with ties to underlying physics, and to create lightweight models appropriate for on-vehicle controls.

Here, we first outline a physics-based OCV model. Using experimental SOC-OCV data from four cells, we fit the OCV model to the data and demonstrate how SOC-OCV curve change creates error in SOC, capacity, and SOCE estimation.

### A Physics-Based Battery OCV Model

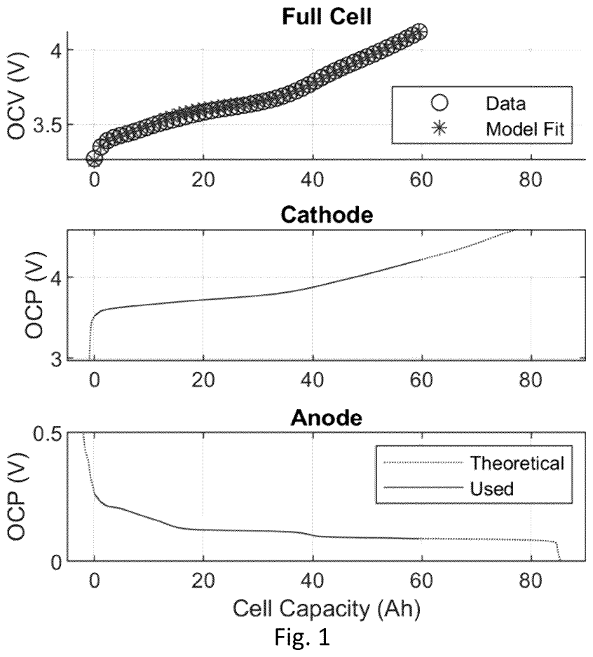

A battery cell has two electrodes—an anode and a cathode—that contribute to the cell OCV. Each electrode has a chemistry-specific OCP curve that varies with its State of Lithiation (SOL). The cell OCV is the difference between the cathode and the anode potential (Equation 2, FIG. 1), where the subscript cell corresponds to the full cell, the subscript p corresponds to the cathode or positive electrode, and the subscript n corresponds to the negative electrode or anode. Ah refers to the capacity stored in the cell at a given state.

$${OCV}_{c e l l} ( A h ) = {OCP}_{p} ( {SOL}_{p} ( A h ) ) - {OCP}_{n} ( {SOL}_{n} ( A h ) ) \qquad ( 2 )$$

Typically, the SOC-OCV relationship is characterized at BOL using a new cell and is treated as static over the life of the battery, at least for the purpose of vehicle controls. This represents new cells well, but as cells age, they deviate from the nominal SOC-OCV curve.

The change in the SOC-OCV relationship measured experimentally can be explained and better understood using the OCV model presented. Holding the electrode SOL-OCP relationships from beginning of life constant, change in the OCV can be from several sources. Intrinsic capacity loss in the anode and cathode can be captured by allowing the electrode intrinsic capacity retention (CapRetₙ and CapRetₚ) to decrease. Additionally, the portion of the SOL used in each electrode can change. We capture this by allowing the maximum capacity of the anode and cathode to shift (Ah_{n,max}, Ah_{p,max}). This is represented in Equations 3-9, with subscript n indicating the negative electrode or anode and subscript p representing the positive electrode or cathode.

$$A {h}_{n , min} = A {h}_{n , max} - {Q}_{a g e d} \qquad ( 3 )$$

$$A {h}_{n , used} = A {h}_{n , max} : \frac{( A {h}_{n , min} - A {h}_{n , max} )}{c - 1} : A {h}_{n , min} \qquad ( 4 )$$

$${OCP}_{n , u s e d} = interpolate ( A {h}_{n} * C a p R e {t}_{n} , {Ocp}_{n} , A {h}_{n , u s e d} ) \qquad ( 5 )$$

$$A {h}_{p , min} = A {h}_{p , max} - {Q}_{a g e d} \qquad ( 6 )$$

$$A {h}_{p , used} = A {h}_{p , max} : \frac{( A {h}_{p , max} - A {h}_{p , min} )}{c - 1} : A {h}_{p , min} \qquad ( 7 )$$

$${OCP}_{p , u s e d} = interpolate ( {Ah}_{p} * C a p R e {t}_{p} , {OCP}_{p} , A {h}_{p , u s e d} ) \qquad ( 8 )$$

$${OCV}_{fit} = {OCP}_{p , u s e d} - {OCP}_{n , used} \qquad ( 9 )$$

Where, Ah=the capacity stored in the cell at a given state, Q_{aged}=the total capacity of an aged cell, c=the count of elements in OCV_{aged}, OCP=the electrode open circuit potential, and CapRet=the intrinsic capacity retention of an electrode.

In Equations 5 and 8, d=interpolate(a,b,c) indicates that a and b are vectors of identical size, c is located in a, and the corresponding element of b is returned as d, e.g., linear interpolation.

Once physical limits—such as preventing electrode capacity from exceeding BOL values Ahₚ and Ahₙ and ensuring aged capacity of the battery Q_{aged} is available—are accounted for, the four parameters CapRetₙ, CapRetₚ, Ah_{n,max}, and Ah_{p,max} can be optimized to minimize error between the experimentally measured and modeled SOC-OCV. This work uses the root mean squared error with any non-numerical errors replaced by 100. Additionally, CapRetₙ was fixed at 100% due to measurement precision limitations.

This results in a modeled aged SOC-OCV curve that can be summarized in terms of electrode intrinsic capacity retention; high, low, and delta SOL; and high and low electrode capacity used.

### Aged OCV Data

We examine four production cells with nickel manganese cobalt (NMC) Li-ion chemistry that have been aged via cycling at 25° C. Each aged cell underwent an SOC-OCV characterization test; when the SOC-OCV characterization was conducted, the cells were measured to have 82.6% to 87.2% capacity retention relative to nominal BOL capacity. The SOC-OCV characterization consisted of a charge to 100% SOC followed by discharging the battery at a rate of C/3 in 2% SOC intervals; at each SOC, the cell rested for at least 4 hours to allow the measured battery voltage to relax to the OCV.

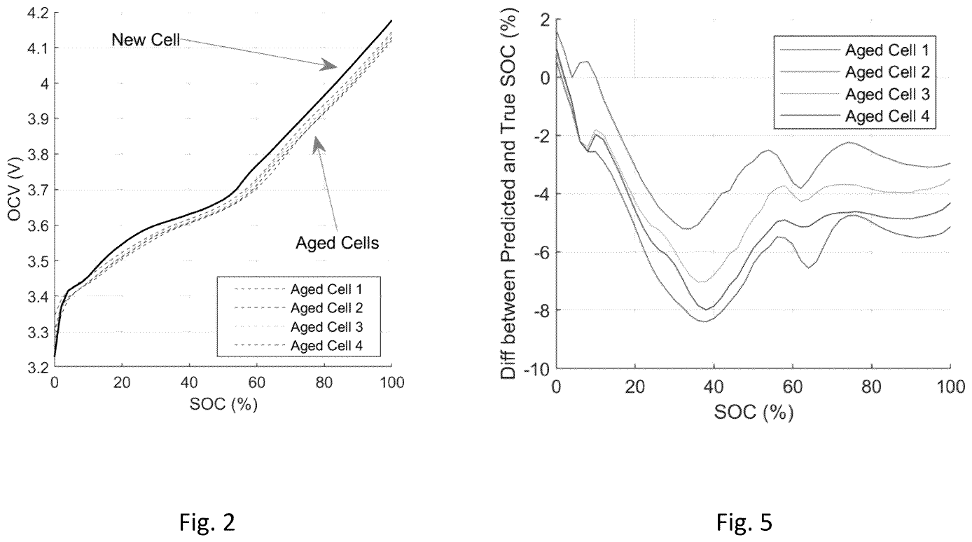

SOC-OCV characterization of aged battery cells shows that the relationship is measurably different from beginning of life. As shown in FIG. 2, at BOL, the SOC-OCV curves for the four cells match well with the representative BOL SOC-OCV curve (solid line). However, after the cells have aged (dashed lines), the OCV measured at 100% SOC is 33 to 56 mV lower than at BOL. This shift downward continues until about 10% SOC, after which point the pattern is more varied between cells.

### Fitting the SOC-OCV Model to Aged Data

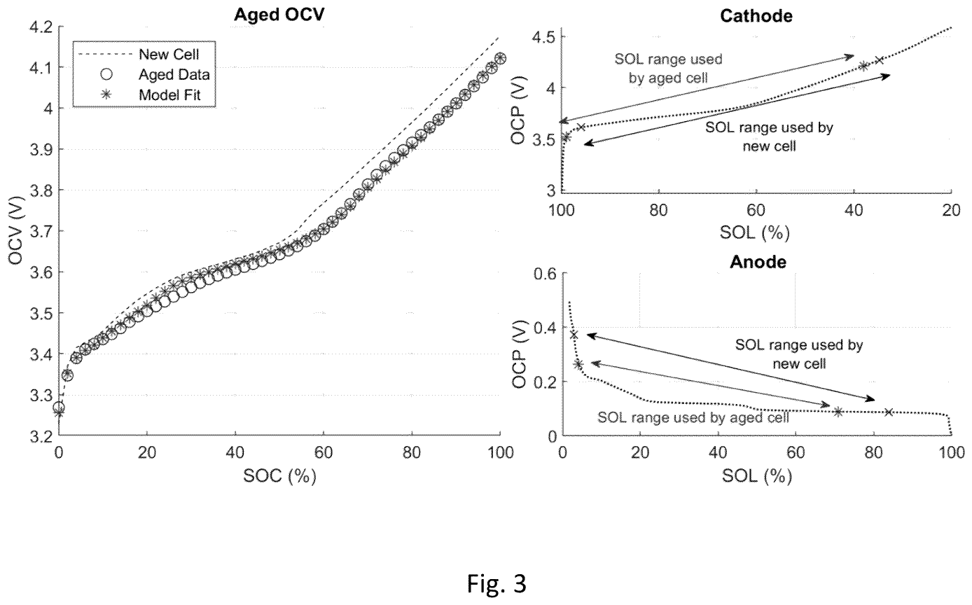

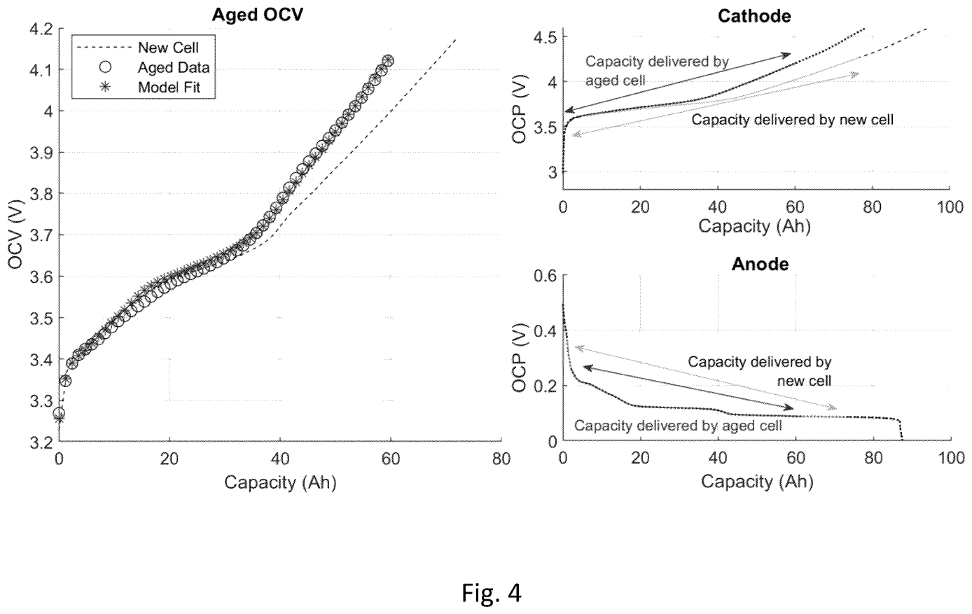

Using the physics-based OCV model, an example result is shown for aged cell 1 in FIGS. 3 and 4. This cell retains 82.6% of the BOL capacity, and the measured OCV curve has shifted to lower voltages for most SOCs. From the OCV model, FIG. 3 shows that the cathode SOL window has shifted to lower OCPs, possibly due to resistance growth. Conversely, the anode SOL window has shrunk to accommodate a loss in intrinsic cathode capacity. This is illustrated more directly in FIG. 4, where the maximum capacity stored in the cathode is smaller for the aged cell. These insights could offer clues to what physical changes have occurred in the aged cell and what degradation mechanisms drove those changes.

### Aged SOC-OCV and SOC Estimation Accuracy

In vehicle battery controls and modeling, OCV is used to predict battery voltage. Additionally, it can be used to estimate SOC. Using the BOL SOC-OCV relationship to predict SOC for an aged cell can result in incorrectly estimating the true SOC and the amount of energy in the battery.

SOC is often estimated through a relationship between SOC and OCV. However, if the characterized SOC-OCV no longer represents the cell in question, the resulting SOC estimate will be incorrect. The difference between the predicted and true SOC is calculated using Equation 10; an example of the results for our four aged cells is shown in FIG. 5. For most SOCs, SOC is overestimated by between 2.2% to 8.4%, representing an underestimate of stored energy and potential vehicle range. Below about 15% SOC, SOC error is more varied between cells and ranges between-3.9% and 1.6%.

$${SOC}_{D i f f} = {SOC}_{B O L} ( {OCV}_{m e a s} ) - {SOC}_{T r u e} = {SOC}_{B O L} ( {OCV}_{M e a s} ) - {SOC}_{A g e d} ( {OCV}_{M e a s} ) \qquad ( 10 )$$

Where suffixes indicate as follows, Meas=Measured value, True=True value, BOL=Beginning of life, Aged=Aged, Diff=Difference.

### Aged SOC-OCV and Capacity and Energy Calculations

Just as an inaccurate SOC-OCV relationship can affect SOC estimation, it also affects capacity and energy estimation. Equation 11 shows a simple way to calculate battery capacity as the ratio between Amp hour throughput measured during an event and the change in SOC during an event (ΔSOC), where the change in SOC is calculated as the difference between initial and final SOC. A simple way to approximate SOCE is to scale capacity (Q_{aged}) by the average voltage (Vₐᵥₑ) measured during an event (Equation 12).

$${Q}_{a g e d} = \frac{A {h}_{m e a s}}{Δ SOC} \qquad ( 11 )$$

$$SOCE ≅ {Q}_{a g e d} * {V}_{a v e} = \frac{A {h}_{m e a s}}{Δ S O C} * {V}_{a v e} \qquad ( 12 )$$

Consider a scenario where the OCV and Amp-hour throughput are perfectly measured and contribute no error. This means that error in the difference in SOCs will directly contribute to estimates of capacity and SOCE (Equation 13). In reality, we recognize that measurement limitations and other sources of error will also contribute to SOCE and capacity uncertainty.

$${SOCE}_{e r r o r} ( {SOCE}_{e r r o r )} ∝ {Q}_{aged , error} ( {SOC}_{e r r o r} ) ∝ \frac{Δ SOC}{Δ SOC + Δ SO {C}_{e r r o r}} - 1 \qquad ( 13 )$$

For in-vehicle capacity and SOCE, estimation methods need to be robust to customer usage. Each customer will drive their vehicle differently-some may regularly fully discharge their battery, while others may consistently use their battery only at high states of charge. We evaluate SOCE and capacity error for any combination of initial and final SOC where the change is greater than 20% SOC.

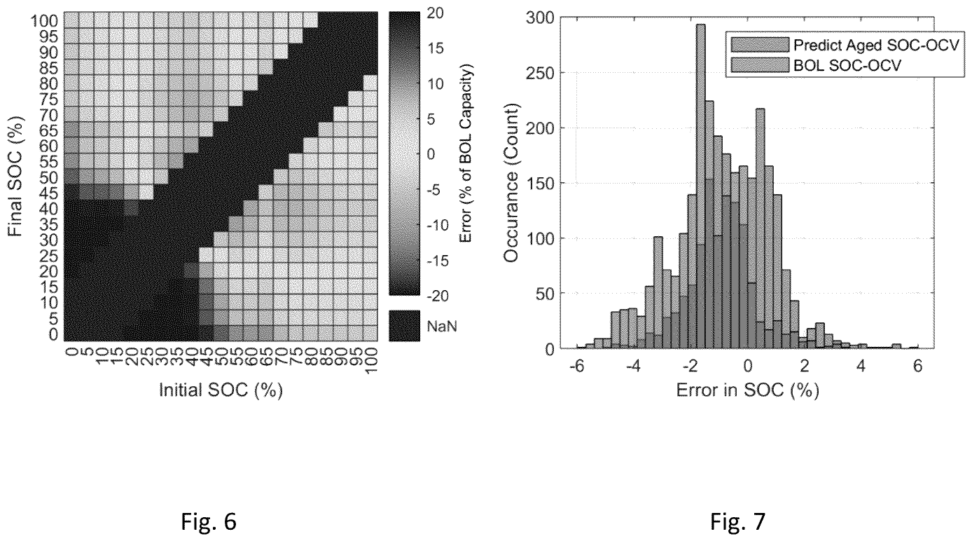

An example of error due to SOC-OCV inaccuracy is shown for aged cell 1 in FIG. 6. For this aged cell, error ranges from −10% to 35% and depends on initial and final SOC. SOC windows that cross from above to below 20% SOC have the most error. This is because the slope of the error due to SOC-OCV change is large in this region and it changes from negative to positive error (see FIG. 5). This effect is most noticeable for smaller changes in SOC (e.g. <40% ΔSOC). For many other SOC combinations, the error in SOC change is lower than the error on either SOC measurement. This is because error from the two SOC measurements is biased and can cancel as part of the calculation.

Given that various SOCE guidelines require the estimated value to be less than 105% of the true value, SOC-OCV inaccuracy alone will violate this requirement for many SOC combinations unless it is considered and accounted for properly.

### Accounting for Aged SOC-OCV

Potential strategies to consider this SOC-OCV change with life could include only updating capacity and SOCE after events with SOC windows less affected by aging or by adjusting the SOC-OCV with life. Here, we illustrate the effects of a method to predict SOC-OCV change with battery degradation.

A control-oriented SOC-OCV model based on Equations 2-9 and calibrated using experimentally measured aged SOC-OCV data can reduce error in SOC estimated from OCV. For example, we have developed a model that predicts the SOC-OCV curve for an aged cell and provides SOC estimation accuracy.

This method was evaluated on reference performance test (RPT) data collected during life cycle testing on 25 cells aged under varied temperature, SOC, and discharge rate scenarios. OCV measurements were taken after 1 hour of rest at 5%, 20%, 50%, and 90% SOC during each RPT. The control-oriented SOC-OCV model reduces mean OCV error from 12.6 mV to 1.44 mV. As shown in FIG. 7, using a predictive aged SOC-OCV model reduces SOC estimation error from a mean of −1.6% to a mean of −0.25%—an 84% reduction—while maintaining a standard deviation of 1.4%.

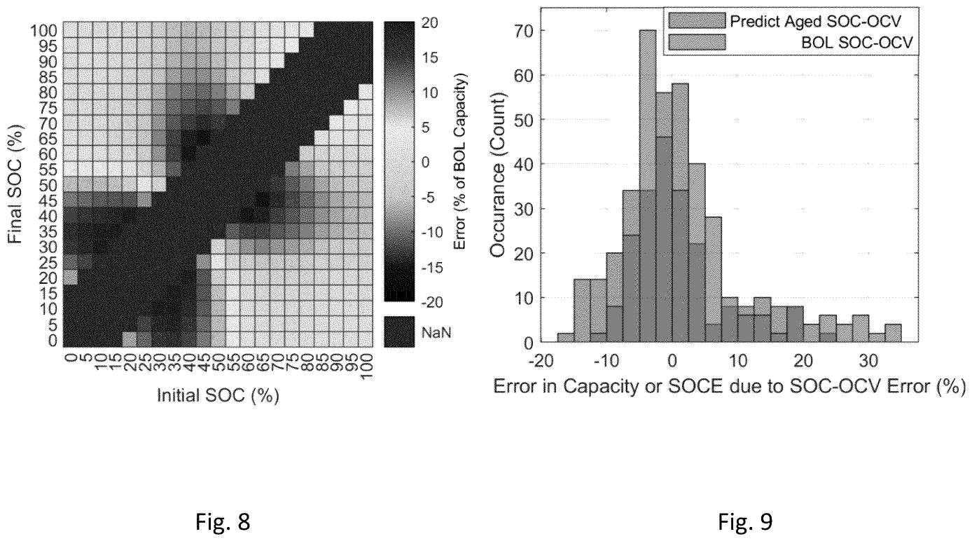

This propagates through to the calculation of capacity and SOCE. As an example, we investigate the capacity and SOCE error due to aged SOC-OCV for aged cell 1. As in the BOL SOC-OCV case (FIG. 6), the accuracy depends on the SOC inputs. For this aged cell, error ranges from −16.3% to 24.6%. SOC combinations that result in relatively high error magnitudes are different than when the BOL SOC-OCV is used (FIG. 8). In addition to accuracy challenges for SOC windows that go below 25% SOC, SOC windows near 60-80% SOC have relatively high error.

With the predicted aged SOC-OCV, mean error drops from 2.8% to −0.26% and error standard deviation decreases from 9.2% to 8.2%. The predicted aged SOC-OCV centers error produces a tighter distribution of error closer to zero and delivers 10% more SOC combinations with error of ±5% per the SOCE accuracy guidelines (83% vs. 73.2%). However, fewer SOC combinations fall within the ±5% uncertainty. While with BOL SOC-OCV 62% of SOC combinations are within this range, only 56% are within this range when using the predicted aged SOC-OCV (see FIG. 9).

### CONCLUSION

With time and use, batteries degrade, generally resulting in higher resistance, lower capacity, and a shifting SOC-OCV relationship. While the SOC-OCV is often treated as static in modeling and controls applications, we have shown that assuming the BOL SOCOCV relationship can result in error in SOC estimation of up to 10% and capacity and energy error of more than 20%. Error in SOC will affect estimated range displayed to the customer.

We have illustrated a control-oriented method to reduce average SOC estimation error by more than 80% and reduces average SOCE estimation error by more than 90% for aged batteries. This method resulted in 10% more SOC combinations meeting requirements with error less than ±5%. However, neither BOL SOC-OCV nor the proposed method achieved more than 62% of SOCE error within ±5%.

The above provides experimental and modeling evidence that the relationship between a traction battery's state of charge and open-circuit voltage changes as the battery ages. Over time, the usable capacity of the battery decreases due to electrode degradation and loss of active lithium inventory. Consequently, vehicle battery controllers that assume a static state-of-charge to open-circuit-voltage relationship can misestimate the state of charge and overstate available energy. We extend these findings into practical vehicle control architectures that adapt charging and energy-management behavior in view of updated capacity information even when open-circuit voltage remains substantially constant.

### Example Implementations

A vehicle may include a traction battery composed of one or more electrochemical cells, each cell having a positive electrode, a negative electrode, and an electrolyte. The battery may supply power to a traction motor or other propulsion component. The vehicle also includes one or more controllers, such as a battery energy control module, powertrain control module, or charger controller, programmed to monitor battery conditions and to control charging, discharging, and energy recovery operations. The controllers may receive voltage, current, temperature, and capacity-related data from sensors or from learned models stored in nonvolatile memory.

The controllers are programmed to maintain and output a SOC value representing the ratio of remaining charge to the available capacity of the battery. Unlike other systems that assume the available capacity is fixed or that rely solely on the SOC-OCV curve, the SOC may be recalculated based on an updated capacity value for the traction battery even when no change is detected in the OCV values. The updated capacity value may be derived from coulomb-counting data, degradation models, or periodic diagnostic tests.

As batteries age, their intrinsic capacity retention decreases. The experimental results above show that the aged SOC-OCV curve can shift downward by only tens of millivolts while the total usable capacity decreases by more than 10%. To accommodate this phenomenon, the controllers disclosed herein are configured to generate a SOC value according to a ratio of measured charge throughput to updated available capacity. Because this computation does not depend on a change in OCV, the controller can recognize that the same terminal voltage now represents a higher relative SOC to reduced capacity. The controller may perform this recalculation periodically, upon detection of a discrepancy between expected and measured amp-hour throughput, or after diagnostic charge-discharge events.

Once the SOC value is calculated, the controller compares it to one or more threshold values. If the value exceeds a charge-prevention threshold, the controller initiates one or more actions. These actions may include commanding the on-board charger to terminate current flow or isolating the battery pack from the external power source, gradually tapering the charging current to a reduced level to not exceed cell voltage limits, or temporarily suspending regenerative energy recovery when the battery state of charge exceeds the threshold. Each of these actions may be implemented using software routines executed by the controller or through direct actuation of contactors, inverter controls, or charger electronics. Because the trigger condition is based on the recalculated SOC, the vehicle can prevent charge even under conditions where voltage readings alone would not signal a full battery.

The controller may also output for display a SOCE or other capacity-related metrics derived from the SOC value. For example, a vehicle display, mobile application, or telematics interface may present an updated SOCE value calculated as the ratio of usable aged energy to certified usable energy. This value may be rounded and displayed to the driver to satisfy requirements. In some embodiments, the controller modifies a displayed maximum charge percentage or range indicator in proportion to the SOC, thereby providing the operator with an accurate representation of the remaining energy. These displayed outputs serve as externally observable manifestations of the control logic.

In certain embodiments, the controllers detect that the SOC associated with the battery has increased by more than a predefined amount (e.g., 10%, 20%, etc.) without a corresponding increase in OCV. Such a condition may occur, for example, after recalculation of capacity following a rest period or data update. Responsive to this condition, the controller executes the charge-prevention sequence described above.

A related strategy includes generating a SOC value for a traction battery responsive to a capacity value that has changed without a corresponding change in OCV and preventing charging of the battery when the generated SOC value exceeds a threshold. Additional steps may include reducing charge current and disabling regenerative braking in response to that condition. The strategy may be executed continuously during charging sessions or periodically during rest intervals of the vehicle.

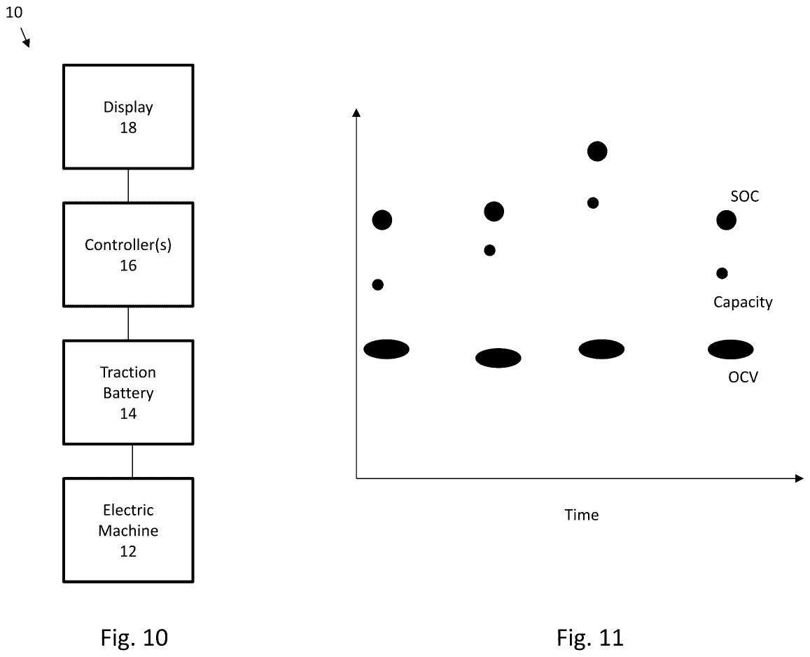

In FIG. 10, a vehicle 10 includes an electric machine 12, a traction battery 14, one or more controllers 16, and a display 18. The electric machine 12 may operate as a motor to provide torque for vehicle propulsion and, in some cases, as a generator to recover energy during regenerative braking. The traction battery 14 supplies electrical energy to the electric machine 12 and receives energy during regenerative events or external charging. The one or more controllers 16 are configured to manage operation of the traction battery 14 and the electric machine 12, including control of charging, discharging, and regenerative braking functions. The controllers 16 may further determine and output a state of charge value for the traction battery 14 based on capacity and voltage information, and may command charge prevention or current reduction in response to the determined state of charge. The display 18 may present information such as the battery's state of charge, range estimates, or other energy-related data to the vehicle operator based on signals provided by the controllers 16.

SOC, capacity, and OCV are illustrated as functions of time in FIG. 11. Over successive time intervals, the SOC and capacity values of the traction battery change, while the corresponding OCV values remain relatively unchanged. This relationship demonstrates that updates to capacity and SOC can occur independently of variations in OCV. In particular, even though the OCV remains nearly constant over time, recalculated capacity values cause the controller to determine different SOC values.

The algorithms, methods, and processes described herein may be implemented or executed by a computer, controller, or other processing device, including any dedicated or programmable electronic control unit. These algorithms, methods, and processes may be stored as data and executable instructions in various forms, such as information permanently stored on non-writable media (for example, read-only memory) or information stored on writable media (for example, compact discs, random access memory, or other magnetic or optical storage devices). They may also be embodied in software executable objects. In some implementations, the algorithms, methods, and processes may be realized in whole or in part through hardware components, such as application-specific integrated circuits, field-programmable gate arrays, state machines, or other suitable hardware devices, or through any combination of firmware, hardware, and software elements.

Although specific embodiments are described above, they are not intended to represent all possible implementations. The terms used in this description are intended to illustrate rather than to limit, and it will be understood that various modifications and substitutions may be made without departing from the scope of the disclosed subject matter. Furthermore, features described in connection with different embodiments may be combined or rearranged to create additional implementations.

What is claimed is:

1. A vehicle comprising:
a traction battery; and
one or more controllers programmed to
output a state of charge value for the traction battery based on a capacity value for the traction battery such that as the capacity value changes and a corresponding open circuit voltage value remains same, the state of charge value changes, and
prevent charge of the traction battery after the state of charge value exceeds a value.

2. The vehicle of claim 1, wherein the one or more controllers are further programmed to output a state of certified energy value based on the state of charge value.

3. The vehicle of claim 1, wherein the one or more controllers is further programmed to modify a displayed charge percentage based on the state of charge value.

4. The vehicle of claim 1, wherein the one or more controllers is further programmed to modify a displayed range indicator based on the state of charge value.

5. The vehicle of claim 1, wherein the one or more controllers are further programmed to reduce charge current to the traction battery after the state of charge value exceeds the value.

6. The vehicle of claim 1, wherein the one or more controllers are further programmed to disable regenerative braking energy recovery after the state of charge value exceeds the value.

7. A vehicle power system comprising:
one or more controllers programmed to prevent charge of a traction battery after a state of charge value associated with the traction battery increases by more than an amount without a corresponding increase in open circuit voltage values associated with the traction battery.

8. The vehicle power system of claim 7, wherein the one or more controllers are further programmed to output for display a state of certified energy value based on the state of charge value.

9. The vehicle power system of claim 7, wherein the one or more controllers is further programmed to modify a displayed charge percentage based on the state of charge value.

10. The vehicle power system of claim 7, wherein the one or more controllers is further programmed to modify a displayed range indicator based on the state of charge value.

11. A method comprising:
generating a state of charge value for a traction battery responsive to a capacity value for the traction battery that is not accompanied by a change in an open circuit voltage value for the traction battery; and
preventing charge of the traction battery responsive to the state of charge value exceeding a value.

12. The method of claim 11 further comprising reducing charge current to the traction battery responsive to the state of charge value exceeding the value.

13. The method of claim 11 further comprising disabling regenerative braking energy recovery responsive to the state of charge value exceeding the value.
